(19) United States
(12) Patent Application Publication
(10) Pub. No.: US 2026/0192198 A1
(43) Pub. Date: Jul. 9, 2026

(54) METHOD AND APPARATUS FOR MARKING VIRTUAL ITEM, AND COMPUTER DEVICE AND STORAGE MEDIUM

(71) Applicant: NETEASE (HANGZHOU) NETWORK CO., LTD., Hangzhou (CN)

(72) Inventor: Mingxin WU, Hangzhou (CN)

(21) Appl. No.: 19/130,829

(22) PCT Filed: Apr. 18, 2023
(86) PCT No.: PCT/CN2023/088984

§ 371 Date: May 16, 2025

(30) Foreign Application Priority Data
Nov. 16, 2022 (CN) 202211436820.6

(51) Int. Cl. A63F 13/5372; A63F 13/52

(52) U.S. Cl. CPC A63F 13/5372; A63F 13/52

(57) ABSTRACT

The present disclosure provides a method for marking a virtual item, the method including: controlling, in response to a movement instruction, a first virtual character to move in a game scene; determining two target virtual items from the game scene based on position information of the first virtual character; acquiring a pick-up parameter of the second virtual character, and determining a first target virtual item from the two target virtual items based on the pick-up parameter; sending and displaying marking information corresponding to the first target virtual item to a terminal device corresponding to the second virtual character; and, in response to a marking instruction triggered with regard to a second target virtual item, sending and displaying marking information corresponding to the second target virtual item to the terminal device corresponding to the second virtual character.

### CROSS-REFERENCED TO RELATED APPLICATIONS

The present disclosure is a 371 national phase application of PCT Application No. PCT/CN2023/088984 filed Apr. 18, 2023, which claims priority to Chinese Patent Application No. 202211436820.6 filed on Nov. 16, 2022, entitled “METHOD AND APPARATUS FOR MARKING VIRTUAL ITEM, AND COMPUTER DEVICE AND STORAGE MEDIUM”, the entire contents of both of which applications are hereby incorporated by reference for all purposes.

### TECHNICAL FIELD

The present disclosure relates to the technical field of computers, and in particular, to a method and an apparatus for marking a virtual item in multiplayer game scenes.

### BACKGROUND

In game scenes of some mobile or client games, players need to find and pick up various game items, and utilize these picked-up game items to complete game tasks.

In related game scenes, players can team up with friends to play, and when a game player discovers supplies during gameplay, the player may send supply marking information to teammate players to prompt them to pick up the supplies. Existing supply marking information needs to be sent by the player to the teammate players by triggering an operation on a supply mark control of a game interface, which affects the game operation of the player, results in poor game experience, increases the running time of a terminal device, and causes high power consumption of the terminal device.

### SUMMARY

Embodiments of the present disclosure provide a method, system, and apparatus for marking a virtual item in a game scene.

According to a first aspect, the present disclosure provides a method for marking a virtual item, including: controlling, in response to a movement instruction for a first virtual character, the first virtual character to move in a game scene, where the game scene is displayed on a graphical user interface provided by a terminal device, the graphical user interface comprises at least a portion of the game scene, the first virtual character and a second virtual character are located in the game scene, the first virtual character corresponds to the terminal device, and the second virtual character and the first virtual character are in a same faction; determining two target virtual items from the game scene based on position information of the first virtual character; acquiring a pick-up parameter of the second virtual character, and determining a first target virtual item from the two target virtual items based on the pick-up parameter; sending and displaying marking information corresponding to the first target virtual item to a terminal device corresponding to the second virtual character; and in response to a marking instruction triggered with regard to a second target virtual item through the graphical user interface, sending and displaying marking information corresponding to the second target virtual item to the terminal device corresponding to the second virtual character, wherein the second target virtual item is one of the two target virtual items.

According to a second aspect, the present disclosure provides a system including one or more memory collectively containing one or more programs, and one or more processors, where the one or more processors are configured to, individually or collectively, perform the operations of one or more steps of the above-described method for marking a virtual item in a game scene.

According to a third aspect, the present disclosure provides one or more non-transitory computer-readable storage media containing, in any combination, computer program code that, when executed by a computer system, perform operations of one or more steps of the above-described method for marking a virtual item in a game scene.

### BRIEF DESCRIPTION OF THE DRAWINGS

In order to more clearly illustrate the technical solutions in the embodiments of the present disclosure, the accompanying drawings used in the description of the embodiments will be briefly described below, and it is obvious that the accompanying drawings in the description below only represent some embodiments of the present disclosure, and for a person skilled in the art, other drawings can also be obtained from these drawings without the exercise of inventive effort.

FIG. 1 is a schematic diagram of a scenario of a system for marking a virtual item provided by one of the embodiments of the present disclosure;

FIG. 2 is a schematic flowchart of a method for marking a virtual item provided by one of the embodiments of the present disclosure;

FIG. 3 is a schematic diagram of an application scenario of a method for sharing a virtual item provided by one of the embodiments of the present disclosure;

FIG. 4 is a schematic diagram of another application scenario of a method for sharing a virtual item provided by one of the embodiments of the present disclosure;

FIG. 5 is a schematic diagram of another application scenario of a method for sharing a virtual item provided by one of the embodiments of the present disclosure;

FIG. 6 is a schematic diagram of another application scenario of a method for marking a virtual item provided by one of the embodiments of the present disclosure;

FIG. 7 is a schematic diagram of another application scenario of a method for marking a virtual item provided by one of the embodiments of the present disclosure;

FIG. 8 is a schematic flowchart of another method for marking a virtual item provided by one of the embodiments of the present disclosure;

FIG. 9 is a schematic diagram of another application scenario of a method for marking a virtual item provided by one of the embodiments of the present disclosure;

FIG. 10 is a structural block diagram of an apparatus for marking a virtual item provided by one of the embodiments of the present disclosure; and

FIG. 11 is a schematic structural diagram of a computer device provided by one of the embodiments of the present disclosure.

### DETAILED DESCRIPTION

The technical solutions in the embodiments of the present disclosure will be clearly and completely described below with reference to the drawings in the embodiments of the present disclosure, and it is obvious that the described embodiments are only a part of the embodiments of the present disclosure, but not all of the embodiments. All other embodiments obtained by persons skilled in the art based on the embodiments of the present disclosure without the exercise of inventive effort shall fall within the scope of protection of the present disclosure.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when” or “while”, or “in response to . . . , it is determined that”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components, that are directly or indirectly linked together, to perform a particular function.

The embodiments of the present disclosure provide a method and an apparatus for marking a virtual item, a storage medium, and a computer device. Specifically, the method for marking a virtual item according to the embodiments of the present disclosure may be performed by a computer device, where the computer device may be a device such as a terminal or a server. The terminal may be a terminal device such as a smart phone, a tablet computer, a notebook computer, a touch screen, a game console, a personal computer (PC), or a personal digital assistant (PDA). The terminal may further include a client, and the client may be a game application client, a browser client carrying a game program, an instant messaging client or the like. The server may be an independent physical server, a server cluster or a distributed system formed by a plurality of physical servers, or a cloud server that provides basic cloud computing services such as cloud services, cloud databases, cloud computing, cloud functions, cloud storage, network services, cloud communication, middleware services, domain name services, security services, CDNs, and large data and artificial intelligence platforms.

For example, when the method for marking a virtual item runs on a terminal, the terminal device stores a game application program and is configured to present a virtual scene in a game screen. The terminal device is configured to interact with users via a graphical user interface, for example, a game application program is downloaded, installed, and run via the terminal device. The graphical user interface may be provided to users by the terminal device in a variety of ways. For example, the graphical user interface may be rendered and displayed on a display screen of the terminal device, or presented by means of holographic projection. For example, the terminal device may include a touch display screen and a processor. The touch display screen is configured to present a graphical user interface and receiving operation instructions generated by the user acting on the graphical user interface, the graphical user interface includes a game screen, and the processor is configured to run the game, generate the graphical user interface, respond to the operation instructions, and control display of the graphical user interface on the display screen.

For example, when the method for marking a virtual item runs on a server, the method may be implemented as cloud gaming. The cloud gaming refers to a gaming means based on cloud computing. In a running mode of the cloud gaming, a running subject and a game screen presentation subject of a game application program are separated, and the storage and running of the method for marking a virtual item are completed on a cloud gaming server. Game screen presentation is completed on a cloud gaming client which is mainly configured to receive and send game data and present game screens. For example, the cloud gaming client may be a display device having a data transmission function near the user side, such as a mobile terminal, a television, a computer, a handheld computer, or a personal digital assistant. However, the terminal device performing game data processing is the cloud gaming server in the cloud. During gameplay, the user operates the cloud gaming client to send an operation instruction to the cloud gaming server, the cloud gaming server runs a game according to the operation instruction, encodes and compresses data such as game screens, and transmits the data back to the cloud gaming client via a network; and finally, the data is decoded and the game screens are output via the cloud gaming client.

In the present disclosure, a preset marking condition for a virtual character to mark a virtual item in a game scene is triggered, where the present marking condition includes the presence of a target virtual item in the game scene that is at a distance less than a preset distance from the virtual character. Further, a second virtual character is selected from other game characters in the same game faction as the virtual character based on a preset marking-information sending condition, and then marking information of the target virtual item is sent to the second virtual character, so that the second virtual character picks up the target virtual item based on the marking information. The disclosed embodiments facilitate marking operations of players on the virtual item, improve the game experience of players, reduce the running time of the terminal device, and save the power of the terminal device.

Reference is made to FIG. 1 which is a schematic diagram of a scenario of a system for marking a virtual item provided by an embodiment of the present disclosure. The system may include at least one terminal, at least one server, at least one database, and a network. The terminal held by a user can be connected to servers of different games via the network. The terminal is any device with computing hardware capable of supporting and executing software products corresponding to games. Additionally, the terminal has one or more multi-touch-sensitive screens configured to sense and obtain inputs of the user through touch or slide operations performed at multiple points of one or more touch display screens. Furthermore, when the system includes a plurality of terminals, a plurality of servers, and a plurality of networks, different terminals may be connected to each other via different networks and different servers. The network may be a wireless network or a wired network. For example, the wireless network is a wireless local area network (WLAN), a local area network (LAN), a cellular network, a 2G network, a 3G network, a 4G network, a 5G network, or the like. Additionally, different terminals may also be connected to other terminals or connected to the servers via their own Bluetooth networks or hotspot networks. For example, multiple users may go online via different terminals to connect and synchronize with each other via a suitable network to support a multiplayer game. Additionally, the system may include a plurality of databases coupled to different servers, and information related to a game environment may be stored in the databases continuously as different users play the multiplayer game online.

An embodiment of the present disclosure provides a method for marking a virtual item, which may be performed by a terminal or a server. The embodiment of the present disclosure is described by taking the method for marking a virtual item being performed by a terminal as an example. The terminal includes a touch display screen and a processor. The touch display screen is configured to present a graphical user interface and receive an operation instruction generated by a user acting on the graphical user interface. When the user operates the graphical user interface via the touch display screen, the graphical user interface may control the local content of the terminal in response to the received operation instruction, or may control the content of a peer server in response to the received operation instruction. For example, the operation instruction generated by the user acting on the graphical user interface includes an instruction for launching a game application program, and the processor is configured to launch the game application program after receiving the instruction for launching the game application program provided by the user. Additionally, the processor is configured to render and draw a graphical user interface associated with the game on the touch display screen. The touch display screen is a multi-touch sensitive screen capable of sensing touch or slide operations simultaneously performed at multiple points on the screen. The user performs a touch operation on the graphical user interface by using a finger, and when the graphical user interface detects the touch operation, different virtual objects on the graphical user interface of the game are controlled to perform an action corresponding to the touch operation. For example, the game may be any one of a casual game, an action game, a role-playing game, a strategy game, a sports game, and an intellective game, etc. The game may include a virtual scene of the game drawn on the graphical user interface. Additionally, the virtual scene of the game may include one or more virtual objects such as virtual characters controlled by the user (or player). Furthermore, the virtual scene of the game may further include one or more obstacles, such as railings, gutters and walls to limit movement of the virtual objects, for example, to limit movement of one or more objects to a specific area within the virtual scene. In some embodiments, the virtual scene of the game further includes one or more elements, such as skills, scores, character health statuses, and energy, to provide assistance to the player, provide virtual services, and increase scores related to player performance, etc. In addition, the graphical user interface may also present one or more indicators to provide the player with indication information. For example, the game may include a player-controlled virtual object and one or more other virtual objects such as enemy characters. In one embodiment, the one or more other virtual objects are controlled by other players of the game. For example, the one or more other virtual objects may be controlled by a computer, e.g., a robot using an artificial intelligence (AI) algorithm, so that a human-computer battle mode is implemented. For example, the virtual object possesses various skills or abilities used by the game player to achieve objectives For example, the virtual object possesses one or more weapons, items, tools, etc. that can be used to eliminate other objects from the game. Such skills or abilities may be activated by players of the game using one of a plurality of preset touch operations on the touch display screen of the terminal. The processor may be configured to present a corresponding game screen in response to operation instructions generated by touch operations of the user.

It should be noted that the schematic diagram of the scene of the system for marking a virtual item shown in FIG. 1 is merely an example, and an image processing system and the scene described in the embodiments of the present disclosure are intended to more clearly illustrate the technical solutions of the embodiments of the present disclosure, but do not constitute a limitation on the technical solutions provided by the embodiments of the present disclosure. It is known to those of ordinary skill in the art that with the evolution of the system for marking a virtual item and the emergence of new business scenarios, the technical solutions provided by the embodiments of the present disclosure remain applicable to similar technical problems.

In view of the above problem, the embodiments of the present disclosure provide a method and an apparatus for marking a virtual item, a computer device and a storage medium, which may improve the game experience of players. Each will be described in detail below. It should be noted that the description order of the following embodiments is not intended to limit the preferred order of the embodiments.

An embodiment of the present disclosure provides a method for marking a virtual item. The method may be performed by a terminal or a server, and the embodiment of the present disclosure will be described using an example in which the method for marking a virtual item is performed by a server.

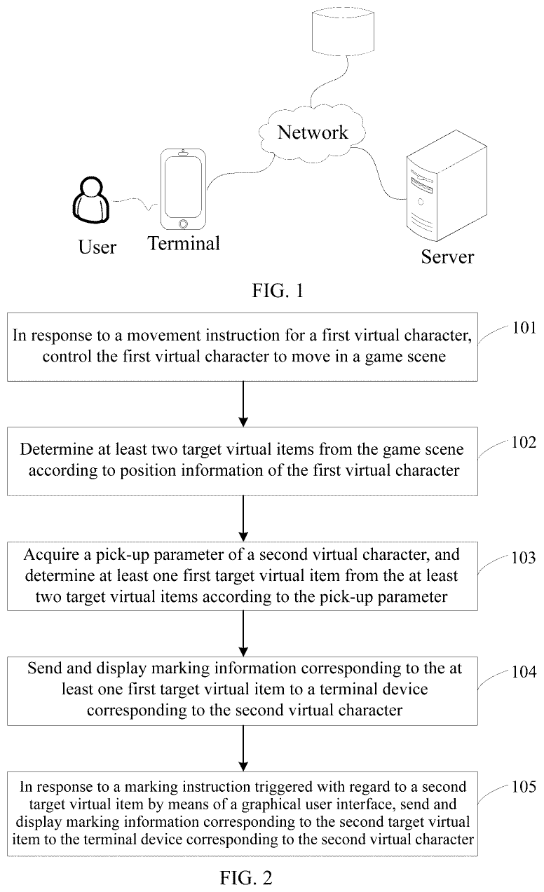

Reference is made to FIG. 2 which is a schematic flowchart of a method for marking a virtual item provided by an embodiment of the present disclosure. The specific process of the method for marking a virtual item may be as follows.

101: A first virtual character is controlled to move in a game scene in response to a movement instruction for the first virtual character.

In the embodiment of the present disclosure, a graphical user interface is provided by a terminal device, and the graphical user interface includes at least a part of the game scene of a target game, as well as a first virtual character and at least one second virtual character that are located in the game scene. The first virtual character corresponds to the terminal device, and more specifically, the first virtual character is a virtual character controlled by a current player operating the terminal device. The second virtual character and the first virtual character are in the same faction, i.e., the second virtual character and the first virtual character may belong to the same game faction in the game, and the second virtual character and the first virtual character are teammates of each other.

The movement instruction is triggered by an operation of the current player on the graphical user interface, for example, the graphical user interface provides a movement control that may be configured to control the first virtual character to move in the game scene. The first virtual character may be controlled to move in the game scene through a touch operation of the current player on the movement control.

102: At least two target virtual items are determined from the game scene according to position information of the first virtual character.

In the embodiment of the present disclosure, the game scene may further include virtual items. The virtual items refer to supplies that can be picked up by virtual characters in the game scene. For example, the virtual items may be virtual firearms, virtual shells, and energy potions, etc.

The virtual items may be configured to complete tasks in the target game, for example, the virtual items may be used to sustain survival of the virtual characters in the game scene, and may also be used to defeat other virtual characters, etc. The virtual items may be obtained in a variety of ways. For example, a user may search for virtual items provided within the game scene, request virtual items from other virtual characters, or defeat other virtual characters to obtain virtual items held by them.

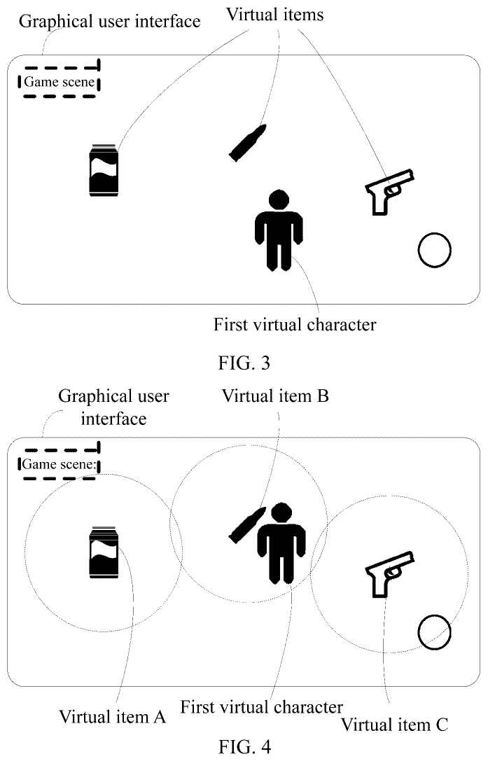

For example, reference is made to FIG. 3 which is a schematic diagram of an application scenario of a method for marking a virtual item provided by an embodiment of the present disclosure. In the graphical user interface shown in FIG. 3, a partial game scene of the target game and a first virtual character controlled by the current player in the game scene are shown, and a plurality of virtual items may also be included in the game scene. The graphical user interface may further provides an operation control that may be configured to control, by the current player, a first virtual object. For example, the operation control may be the movement control, and the current player may control the first virtual character to move in the game scene by operating the movement control.

The position information refers to a scene position of the first virtual character in the game scene.

In some embodiments, in order to select a correctly marked target virtual item from the plurality of virtual items in the game scene, the step of “determining at least two target virtual items from the game scene according to position information of the first virtual character” may include the following operations: determining the distance between the first virtual character and each virtual item in the game scene according to the position information; and determining the target virtual item based on a virtual item at a distance less than a preset distance from the first virtual character.

In the embodiment of the present disclosure, a pickable range is set for the virtual item in the game scene, and the pickable range refers to a position range in which the virtual character can pick up the virtual item in the game scene. For example, the pickable range may be an area divided by taking the virtual item as a center in the game scene. The virtual character within the pickable range for the virtual item may perform a pick-up operation or perform item marking on the virtual item.

For example, reference is made to FIG. 4 which is a schematic diagram of an application scenario of another method for marking a virtual item provided by an embodiment of the present disclosure. Virtual items in a game scene may include: a virtual item A, a virtual item B, and a virtual item C. Pickable ranges (ranges shown by dashed lines in the figure) corresponding to the virtual items are respectively determined based on the positions of the virtual items in the game scene.

Determining the distance between a first virtual character and each virtual item in the game scene according to position information may include: determining the first relative distance between the first virtual character and each virtual item in the game scene according to the position information, the first relative distance being a distance between the first virtual character and the virtual item in the game scene.

For example, reference is still made to FIG. 4, the first relative distance between the first virtual character and the virtual item A may be obtained as: L1; the first relative distance between the first virtual character and the virtual item B may be obtained as: L2; and the first relative distance between the first virtual character and the virtual item C may be obtained as: L3.

Determining a target virtual item based on a virtual item at a distance less than a preset distance from the first virtual character may include: determining, from at least one virtual item, a virtual item at a first relative distance less than the preset distance from the first virtual character, to obtain the target virtual item.

The preset distance may be configured to determine whether the first virtual character is within a pickable range of the virtual item, for example, the preset distance may be 200 meters in the game scene. There may be a plurality of target virtual items.

For example, it is determined whether the relative distance between the first virtual character and the virtual item A satisfies a preset virtual item marking condition: the first relative distance L1 is compared with the preset distance to obtain a comparison result: the first relative distance L1 is greater than the preset distance; it is determined whether the relative distance between the first virtual character and the virtual item B satisfies the preset virtual item marking condition: the first relative distance L2 is compared with the preset distance to obtain a comparison result: the first relative distance L2 is less than the preset distance; and it is determined whether the relative distance between the first virtual character and the virtual item C satisfies the preset virtual item marking condition: the first relative distance L3 is compared with the preset distance to obtain a result: the first relative distance L3 and the first relative distance L2 are greater than the preset distance, so that it can be determined that the virtual item B and the virtual item B in the game scene are the target virtual items, and then an item marking function may be triggered.

103: A pick-up parameter of the second virtual character is acquired, and at least one first target virtual item is determined from the at least two target virtual items according to the pick-up parameter.

The pick-up parameter refers to a pick-up rule set by a game player corresponding to the second virtual character for the virtual items in the virtual scene, for example, the pick-up rule may include: supplies are picked up/not picked up automatically when the virtual character moves in the game scene, supplies are picked up/not picked up automatically when there is no supplies in a backpack of the virtual character, etc.

In some embodiments, in order to facilitate the second virtual character to quickly obtain the virtual item, the step of “acquiring a pick-up parameter of the second virtual character” may include the following operations: determining a close-range second virtual character based on a second virtual character at a distance not exceeding a preset distance from the first virtual character in the game scene; and acquiring a pick-up parameter of the close-range second virtual character.

In the embodiment of the present disclosure, by sending marking information of the target virtual item to a terminal device corresponding to the second virtual character, the terminal device corresponding to the second virtual character displays the marking information, so that the second virtual character can pick up the target virtual item in the game scene.

In this solution, the marking information of the virtual item may be automatically sent to the second virtual character in the virtual scene. The second virtual character may be a second virtual character that satisfies automatic sending of the marking information, for example, a second relative distance between the second virtual character and the first virtual character is less than the preset distance.

The second virtual character needs to move to the pickable range of the target virtual item in the game scene to pick up the target virtual item. In the embodiment of the present disclosure, in order to facilitate the second virtual character to pick up the target virtual item, a virtual character closer to the first virtual character may be selected from a game faction to which the first virtual character belongs.

The second relative distance refers to a distance between a virtual character belonging to the same game faction as the first virtual character and the first virtual character in the game scene. Then, the second relative distance between the first virtual character and the virtual character in the same game faction is compared with the preset distance, and according to a comparison result, the virtual character closer to the first virtual character is determined as the second virtual character to which the marking information is automatically sent, specifically, a close-range second virtual character.

For example, in the target game, the game faction to which the first virtual character belongs may be: a first game faction. The first game faction includes: a first virtual character, a second virtual character a, a second virtual character b, a second virtual character c, etc. In the game scene, the second relative distance between the first virtual character and the second virtual character a may be obtained as: L4; the second relative distance between the first virtual character and the second virtual character b may be obtained as: L5; and the second relative distance between the first virtual character and the second virtual character c may be obtained as: L6.

Further, the second relative distance L4 is compared with the preset distance to obtain a comparison result which may be: the second relative distance L4 is greater than the preset distance; the second relative distance L5 is compared with the preset distance to obtain a comparison result which may be: the second relative distance L5 is less than the preset distance; the second relative distance L6 is compared with the preset distance to obtain a comparison result which may be: the second relative distance L6 is less than the preset distance, so that it may be determined that the close-range second virtual character includes: the second virtual character b and the second virtual character c.

In some embodiments, the step of “acquiring a pick-up parameter of the second virtual character” may include the following operations: acquiring item pick-up setting information corresponding to the second virtual character; and obtaining the pick-up parameter based on the item pick-up setting information.

The item pick-up setting information refers to setting information of pick-up rules for the virtual items in the virtual scene by the game player corresponding to the second virtual character in the target game.

In the embodiments of the present disclosure, a virtual item pick-up setting interface is designed in the target game, and the player may set the item pick-up setting information by operating the item pick-up setting interface.

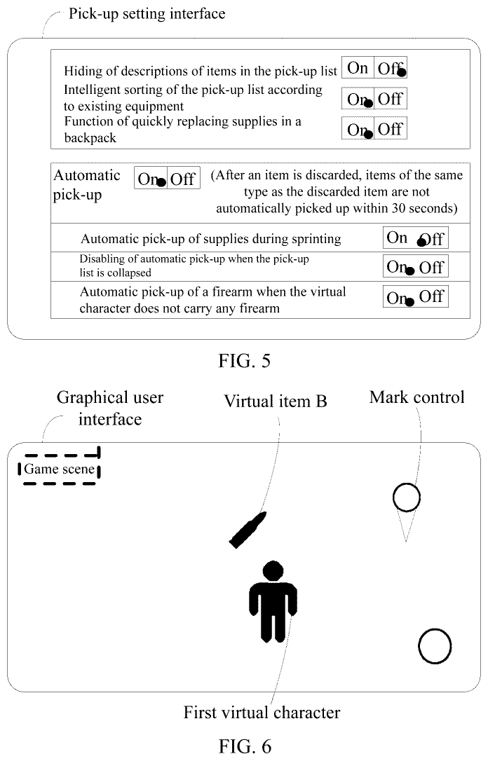

For example, reference is made to FIG. 5 which is a schematic diagram of an application scenario of another method for marking a virtual item provided by an embodiment of the present disclosure. The pick-up setting interface shown in FIG. 5 is an interface for setting pick-up of the virtual items. The pick-up setting interface includes a plurality of item pick-up setting rules: hiding of descriptions of items in the pick-up list, intelligent sorting of the pick-up list according to existing equipment, function of quickly replacing supplies in a backpack, automatic pick-up, automatic pick-up of supplies during sprinting, disabling of automatic pick-up when the pick-up list is collapsed, and automatic pick-up of a firearm when the virtual character does not carry any firearm.

The “hiding of descriptions of items in the pick-up list” refers to hiding description information of virtual items when the virtual item pick-up list is displayed; the “intelligent sorting of the pick-up list according to existing equipment” refers to intelligently sorting virtual items in the pick-up list according to the equipment held by the virtual character; the “function of quickly replacing supplies in a backpack” refers to quickly replacing supplies in a backpack of a virtual character based on virtual items in a pick-up list; the “automatic pick-up” refers to automatically picking up virtual items; the “automatic pick-up of supplies during sprinting” refers to that a virtual character may automatically pick up virtual items in a virtual scene when sprinting in a game scene, the “disabling of automatic pick-up when the pick-up list is collapsed” refers to stopping automatically picking up virtual items in a virtual scene when an expanded pick-up list is collapsed; and the “automatic pick-up of a firearm when the virtual character does not carry any firearm” refers to that a firearm in a virtual scene may be automatically picked up when a virtual character does not hold a firearm. The embodiment of the present disclosure is not limited to the pick-up rule setting for the virtual items shown in FIG. 5.

Still referring to FIG. 5, an on/off control is further provided on the pick-up setting interface, and the player may set a virtual item pick-up rule by using the on/off control. The on/off on the on/off control is used to set on/off of a corresponding function. For example, “on” is set for the on/off control for the rule “hiding of descriptions of items in the pick-up list”, which indicates enabling the “hiding of descriptions of items in the pick-up list”; and For the on/off control of the rule “automatic pick-up”, “on” is set to indicate starting the “automatic pick-up”, etc.

In some embodiments, the pick-up rules may further include: player-configured virtual items selected to be picked up, virtual items not to be picked up, virtual items to be picked up with priority, etc.

In some embodiments, in order to select a virtual item meeting the requirements of the second virtual character to send marking information, the step of “determining at least one first target virtual item from the at least two target virtual items according to the pick-up parameter” may include the following operation: selecting, from the at least two target virtual items, a virtual item that meets the item pick-up setting information, to obtain the first target virtual item.

Specifically, according to the virtual item selected to be picked up and set in the pick-up setting information corresponding to a close-range second virtual character in the virtual scene, the virtual item in the virtual scene is matched with the item pick-up setting information, and then a virtual item matched with the item pick-up setting information is screened out to obtain a first target virtual item.

For example, the close-range second virtual character in the virtual scene may include: a virtual character a, a virtual character b, and a virtual character c. Acquiring pick-up setting information of the virtual character a may include: the virtual items selected to be picked up include a first virtual item, a second virtual item, and a third virtual item; acquiring pick-up setting information of the virtual character b may include: the virtual items selected to be picked up include the first virtual item, the second virtual item, and a fourth virtual item; acquiring pick-up setting information of the virtual character c may include: the virtual items selected to be picked up include the second virtual item, the fourth virtual item, and a fifth virtual item.

The target virtual item may be: the third virtual item, the virtual item selected to be picked up in the pick-up setting information of each virtual character is then matched with the target virtual item, and it may be determined that the second virtual object that needs to pick up the target virtual item may be: the virtual character a.

104: Marking information corresponding to the at least one first target virtual item is sent and displayed to a terminal device corresponding to the second virtual character.

The marking information refers to information for marking the target virtual item displayed on the graphical user interface.

In some embodiments, the step of “sending and displaying marking information corresponding to the at least one first target virtual item to a terminal device corresponding to the second virtual character” may include the following operation: sending and displaying the marking information corresponding to the at least one first target virtual item to a terminal device corresponding to the close-range second virtual character.

The graphical user interface may further include a marking information display area, and after the first target virtual item required by the close-range second virtual character is determined according to the pick-up parameter of the close-range second virtual character, the marking information for the first target virtual item may be triggered to be sent to the terminal device corresponding to the close-range second virtual character, and meanwhile, the marking information of the first target virtual item is displayed on the graphical user interface, for example, the marking information may be “mark the first virtual item”.

For example, the close-range second virtual character may be: the virtual character a, and if it is determined that according to the pick-up parameter corresponding to the virtual character a, the target virtual item required by the virtual character may be: a firearm A, then marking information of the firearm A may be sent to the virtual character a to facilitate the virtual character a to quickly pick up the firearm A.

105: In response to a marking instruction triggered with regard to a second target virtual item by means of the graphical user interface, marking information corresponding to the second target virtual item is sent and displayed to the terminal device corresponding to the second virtual character.

The second target virtual item is a virtual item among the at least two target virtual items.

In the embodiments of the present disclosure, a manner in which the player manually marks the virtual item and sends the marking information of the virtual item to the terminal device corresponding to the second virtual character is further provided.

In some embodiments, in order to facilitate other second virtual characters that are in the same game faction as the first virtual character and are far away from the first virtual character in the virtual scene to pick up the target virtual item, the step of “sending and displaying marking information corresponding to the second target virtual item to the terminal device corresponding to the second virtual character” may include the following operations: determining a long-range second virtual character based on a second virtual character at a distance exceeding a preset distance from the first virtual character in the game scene; and sending and displaying the marking information corresponding to the second target virtual item to a terminal device corresponding to the long-range second virtual character.

In the embodiments of the present disclosure, in order to facilitate other second virtual characters to pick up the target virtual item, a second virtual character at a second relative distance greater than a preset distance from the first virtual character may be selected from the game faction to which the first virtual character belongs.

The second relative distance refers to a distance between a virtual character belonging to the same game faction as the first virtual character and the first virtual character in the game scene. Then, the second relative distance between the first virtual character and each second virtual character in the game scene is compared with the preset distance, and according to a comparison result, a second virtual character at a distance exceeding the present distance from the first virtual character is determined as the second virtual character to which the marking information is manually sent, specifically, a long-range second virtual character.

For example, in the target game, the game faction to which the first virtual character belongs may be: a first game faction. The first game faction includes: a first virtual character, a second virtual character a, a second virtual character b, a second virtual character c, etc. In the game scene, the second relative distance between the first virtual character and the second virtual character a may be obtained as: L4; the second relative distance between the first virtual character and the second virtual character b may be obtained as: L5; and the second relative distance between the first virtual character and the second virtual character c may be obtained as: L6.

Further, the second relative distance L4 is compared with the preset distance to obtain a comparison result which may be: the second relative distance L4 is greater than the preset distance; the second relative distance L5 is compared with the preset distance to obtain a comparison result which may be: the second relative distance L5 is less than the preset distance; the second relative distance L6 is compared with the preset distance to obtain a comparison result which may be: If the second relative distance L6 is less than the preset distance, it may be determined that the long-range second virtual character includes: the second virtual character a.

In some embodiments, the second target virtual item may be at least one first target virtual item, specifically, a target virtual item that meets the pick-up parameter corresponding to the second virtual object. In order to send the marking information of the required virtual item to the long-range second virtual character, the step of “sending and displaying marking information corresponding to the second target virtual item to a terminal device corresponding to the long-range second virtual character” may include the following operation: sending and displaying marking information corresponding to the at least one first target virtual item to the terminal device corresponding to the long-range second virtual character.

Specifically, the pick-up parameter of the long-range second virtual character is obtained, the first target virtual item that meets the pick-up parameter of the long-range second virtual character is selected from the virtual items in the virtual scene, the marking information of the first target virtual item is then sent to the long-range second virtual character, and at the same time, the marking information of the first target virtual item is displayed on the graphical user interface.

In some embodiments, for other virtual items that do not meet the pick-up parameter of the virtual object in the virtual scene, if there may be a demand from a second virtual object for the other virtual items, then the second target virtual item is a virtual item other than the first target virtual item among the at least two target virtual items. The step of “sending and displaying the marking information corresponding to the second target virtual item to a terminal device corresponding to the long-range second virtual character” may include the following operation: sending and displaying marking information corresponding to the virtual item other than the first target virtual item among the at least two target virtual items to the terminal device corresponding to the long-range second virtual character.

For example, the virtual scene includes a first virtual object, a long-range second virtual character, a virtual item A, a virtual item B, a virtual item C, and a virtual item D. A pick-up parameter of the long-range second virtual character is acquired, each virtual item in the virtual scene is matched with the pick-up parameter of the long-range second virtual character, and it is determined that the virtual items matching the pick-up parameter of the long-range second virtual character may be: the virtual item A and the virtual item B. More specifically, the required virtual items set by the long-range second virtual character may be: the virtual item A and the virtual item B. In this case, the virtual item C and the virtual item D may be virtual items required by the long-range second virtual character, and to prevent the long-range second virtual character from missing picking up required virtual items, the virtual item C and the virtual item D may be manually marked by the player in a manual marking manner, to send marking information of the virtual item C and the virtual item D to the long-range second virtual character.

In some embodiments, in order to facilitate the manual marking operation of the player, after the step of “determining at least two target virtual items from the game scene according to position information of the first virtual character”, the method may further include the following step: providing a mark control on the graphical user interface. The step of “in response to a marking instruction triggered with regard to a second target virtual item by means of the graphical user interface, sending and displaying marking information corresponding to the second target virtual item to the terminal device corresponding to the second virtual character” may include the following operation: in response to an information marking operation on the mark control, sending and displaying the marking information corresponding to the second target virtual item to the terminal device corresponding to the second virtual character.

In the embodiments of the present disclosure, for the second virtual character at a second relative distance less than a preset distance from the first virtual character in the same game faction, when the first virtual character approaches the virtual item, sending the marking information of the virtual item to the second virtual character may be automatically triggered. In order to meet different marking requirements of the game player for the virtual items, a mark control may be designed on the graphical user interface. When there is no second virtual character at a second relative distance less than the preset distance from the first virtual character in the same game faction, a manual marking manner may be performed. More specifically, an operation on the mark control triggers sending of the marking information of the target virtual item to the terminal device corresponding to the long-range second virtual character.

The mark control may not be fixedly displayed on the graphical user interface, and the display trigger condition of the mark control may be: the first virtual character is within a pickable range of the virtual item. Similarly, when the first virtual character moves from the pickable range of the virtual item to the outside of the pickable range, the display of the mark control is canceled, thereby improving the utilization of the screen space.

For example, reference is made to FIG. 6 which is a schematic diagram of an application scenario of another method for marking a virtual item provided by an embodiment of the present disclosure. The first virtual character and the virtual item B are located in the game scene, where the first virtual character may be located in a pickable range of the virtual item B. The graphical user interface may further provides a mark control, and the mark control may be configured to perform a marking operation on the virtual item B.

In some embodiments, in order to meet the pick-up requirement of the virtual character for the target virtual items, before the step of “sending and displaying marking information corresponding to the second target virtual item to the terminal device corresponding to the second virtual character”, the method may further include the following steps: acquiring virtual items held by the first virtual character; and if the target virtual item exists in the held virtual items, performing the step of sending and displaying marking information corresponding to the second target virtual item to the terminal device corresponding to the second virtual character.

The held virtual items may be all virtual items owned by the first virtual character during a game session, and may be virtual items picked up, purchased, or obtained in another way by the first virtual character.

If the virtual items held by the first virtual character include the target virtual item, it may be determined that the first virtual character does not need to pick up the target virtual item again, and then the marking information of the target virtual item may be sent to the terminal device corresponding to the second virtual character in the same game faction.

If the virtual items held by the first virtual character do not include the target virtual item, it may be determined that the first virtual character needs to pick up the target virtual item, and the step of sending the marking information of the target virtual item to the terminal device corresponding to the second virtual character in the same game faction does not need to be performed.

In some embodiments, in order to further satisfy the pick-up requirements of the virtual character for the target virtual items, the method may further include the following step: if the held virtual items include a virtual item of the same type as the target virtual item, performing the step of sending the marking information of the target virtual item to the terminal device corresponding to the second virtual character.

In the embodiments of the present disclosure, the virtual item of the same type as the target virtual item may have the same function/effect as the target virtual item. In this case, when the virtual items held by the first virtual character include a virtual item of the same type as the target virtual item, the virtual item may replace the function of the target virtual item, and at this time, the target virtual item may be left for teammates in need, and marking information of the target virtual item may be sent to the terminal device corresponding to the second virtual character in the same game faction.

In some embodiments, before the step of “sending the marking information of the target virtual item to the terminal device corresponding to the second virtual character”, the method may further include the following steps: acquiring an item type of a target virtual item; and if the item type is a specified type, performing the step of sending the marking information of the target virtual item to the terminal device corresponding to the second virtual character.

In the embodiments of the present disclosure, in order to meet the item marking needs of different players, the players may customize the item type of the virtual items to be marked.

For example, the current player controlling the first virtual character may set the item type of the virtual item to be marked before a game session begins. In the game session, when the first virtual character is within the pickable range of the target virtual item, it is determined whether the item type of the target virtual item is the item type of the virtual item set to be marked by the current player, and if the item type of the target virtual item is the item type of the virtual item set to be marked by the current player, the marking information of the target virtual item may be sent to the terminal device corresponding to the second virtual character in the same game faction. If the item type of the target virtual item is not the item type of the virtual item set to be marked by the current player, the marking information of the target virtual item does not need to be sent to the terminal device corresponding to the second virtual character in the same game faction.

In some embodiments, in order to facilitate the second virtual character to pick up the target virtual item, before the step of “sending the marking information of the target virtual item to the terminal device corresponding to the second virtual character”, the method may further include the following steps: acquiring position information of the target virtual item in the game scene; and generating the marking information based on the target virtual item and the position information.

The position information may be represented by position coordinates of the target virtual item in the game scene, for example, may be represented by longitude and latitude.

Specifically, the generated marking information includes the item name of the target virtual item and the position coordinates of the target virtual item according to the target virtual item and the position information, and then the marking information is sent to the terminal device corresponding to the second virtual character, so that the second virtual character quickly finds the target virtual item in the game scene according to the position coordinates for picking up.

In some embodiments, in order to facilitate the game player to view the marking information, after the marking information of the target virtual item is sent to the terminal device corresponding to the second virtual character, the terminal device corresponding to the first virtual character may display the marking information on the graphical user interface, and meanwhile, the terminal device corresponding to the second virtual character may also display the marking information on the graphical user interface.

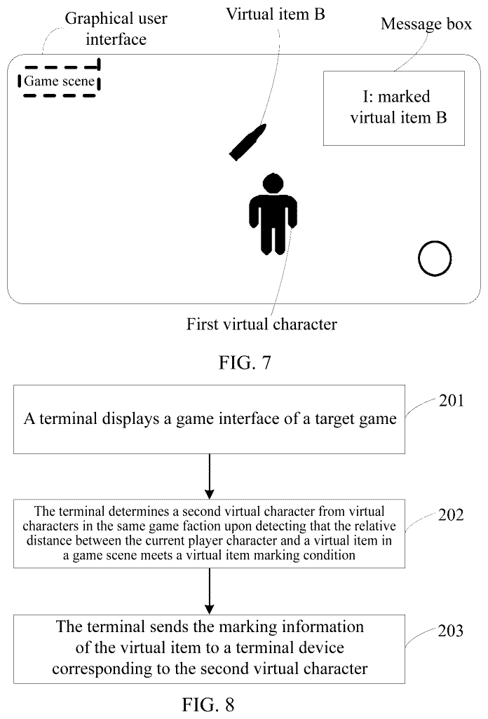

For example, reference is made to FIG. 7 which is a schematic diagram of an application scenario of another method for marking a virtual item provided by an embodiment of the present disclosure. The first virtual character and the virtual item B are located in the game scene, where the first virtual character may be located in a pickable range of the virtual item B. Sending of the marking information to the second virtual character in the same game faction is automatically triggered, and the marking information “I: marked the virtual item B” is displayed in a message box of the graphical user interface, where “I” is the first virtual character.

An embodiment of the present disclosure discloses a method for marking a virtual item. The method includes: when a relative distance between a first virtual character and a target virtual item in virtual items meets a preset virtual item marking condition, marking information of the target virtual item is sent to a terminal device corresponding to a second virtual character, where the second virtual character and the first virtual character belong to the same game faction, so that the game experience of the player can be improved, the running time of the terminal device can be reduced, and the power of the terminal device can be saved.

According to the content introduced above, the method for marking a virtual item according the present disclosure will be further described below by way of example. Reference is made to FIG. 8 which is a schematic flowchart of another method for marking a virtual item provided by an embodiment of the present disclosure. With the method for marking a virtual item being specifically applied to picking up supplies of an eliminated game player after the game player is eliminated from a game as an example, the specific process may be as follows.

201: A terminal displays a game interface of a target game.

In the embodiment of the present disclosure, the game interface is provided through a terminal device, the game interface may include a part of a game scene of the target game and a current player character in the game scene, the game scene may further include virtual items, and the current player character may pick up the virtual items to obtain the virtual items. The current player character may be a virtual object controlled by the current game player.

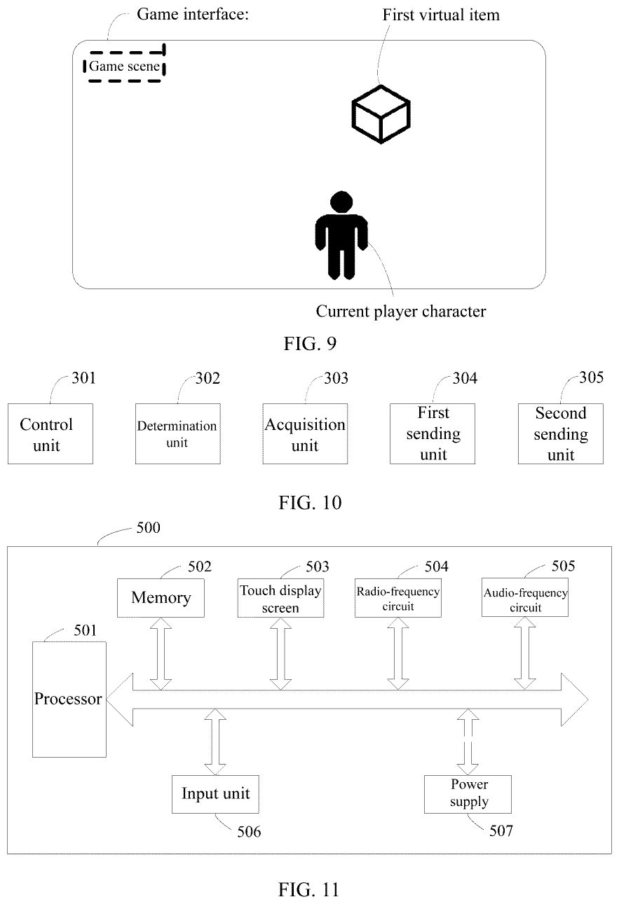

For example, reference is made to FIG. 9 which is a schematic diagram of an application scenario of another method for marking a virtual item provided by an embodiment of the present disclosure. In the game interface shown in FIG. 9, a part of the game scene of the target game, the current player character in the game scene, and a first virtual item are displayed.

202: The terminal determines a second virtual character from virtual characters in the same game faction in response to detecting that a relative distance between the current player character and a virtual item in the game scene meets a virtual item marking condition.

Specifically, a first position of the current player character in the game scene is obtained, a second position of the first virtual item in the game scene is obtained, and a relative distance between the current player character and the first virtual item is determined according to the first position and the second position.

Further, whether the current player character and the first virtual item meet a trigger condition for virtual item marking is determined according to the relative distance.

Specifically, the relative distance is compared with a preset distance, and if the relative distance is less than the preset distance, it may be determined that the current player character and the first virtual item meet the trigger condition for virtual item marking.

Further, the second virtual character that meets the marking-information sending condition is determined from other virtual characters in the same game faction as the current player character.

The meeting the marking-information sending condition may include: a distance to the current virtual character is less than the preset distance, and a item pick-up configuration includes picking up the first virtual item. The second virtual character is determined according to the virtual character that meets the marking-information sending condition.

203. The terminal sends the marking information of the virtual item to a terminal device corresponding to the second virtual character.

Specifically, after the second virtual character that meets the marking-information sending condition is determined, sending the marking information of the first virtual item to the second virtual character is automatically triggered, so that the second virtual character picks up the first virtual item.

An embodiment of the present disclosure discloses a method for marking a virtual item. The method includes: in response to a movement instruction for a first virtual character, controlling the first virtual character to move in a game scene; determining at least two target virtual items from the game scene according to position information of the first virtual character; acquiring a pick-up parameter of the second virtual character, and determining at least one first target virtual item from the at least two target virtual items according to the pick-up parameter; sending and displaying marking information corresponding to the at least one first target virtual item to a terminal device corresponding to the second virtual character; and in response to a marking instruction triggered with regard to a second target virtual item by means of the graphical user interface, sending and displaying marking information corresponding to the second target virtual item to the terminal device corresponding to the second virtual character, where the second target virtual item is a virtual item among the at least two target virtual items. In this way, the user quickly sends an acquisition request to the target virtual character that picks up the largest quantity of target game items, so that a user operation can be simplified, thereby improving the game experience of the user, reducing the running time of the terminal device, and saving the power of the terminal device.

To facilitate better implementation of the method for marking a virtual item provided by the embodiments of the present disclosure, an embodiment of the present disclosure further provides an apparatus for marking a virtual item on the basis of the method for marking a virtual item. The terms herein have the same meanings as those in the above method for marking a virtual item, and for specific implementation details, reference may be made to the description in the method embodiments.

Referring to FIG. 10, FIG. 10 is a structural block diagram of an apparatus for marking a virtual item provided by an embodiment of the present disclosure. The apparatus includes: a control unit 301, configured to control, in response to a movement instruction for the first virtual character, the first virtual character to move in the game scene; a determination unit 302, configured to determine at least two target virtual items from the game scene according to position information of the first virtual character; an acquisition unit 303, configured to acquire a pick-up parameter of the second virtual character, and determine at least one first target virtual item from the at least two target virtual items according to the pick-up parameter; a first sending unit 304, configured to send and display marking information corresponding to the at least one first target virtual item to a terminal device corresponding to the second virtual character; and a second sending unit 305, configured to send and display, in response to a marking instruction triggered with regard to a second target virtual item by means of the graphical user interface, marking information corresponding to the second target virtual item to the terminal device corresponding to the second virtual character, wherein the second target virtual item is a virtual item among the at least two target virtual items.

In some embodiments, the acquisition unit 303 may include: a first determination subunit, configured to determine a close-range second virtual character based on a second virtual character at a distance not exceeding a preset distance from the first virtual character in the game scene; and a first acquisition subunit, configured to acquire a pick-up parameter of the close-range second virtual character.

In some embodiments, the first sending unit 304 may include: a first sending subunit, configured to send and display the marking information corresponding to the at least one first target virtual item to a terminal device corresponding to the close-range second virtual character.

In some embodiments, the second sending unit 305 may include: a second determination subunit, configured to determine a long-range second virtual character based on a second virtual character at a distance exceeding a preset distance from the first virtual character in the game scene; and a second sending subunit, configured to send and display the marking information corresponding to the second target virtual item to a terminal device corresponding to the long-range second virtual character.

In some embodiments, the second sending unit 305 may include: a third sending subunit, configured to send and display marking information corresponding to the at least one first target virtual item to the terminal device corresponding to the long-range second virtual character.

In some embodiments, the second sending unit 305 may include: a fourth sending subunit, configured to send and display marking information corresponding to the virtual item other than the first target virtual item among the at least two target virtual items to the terminal device corresponding to the long-range second virtual character.

In some embodiments, the acquisition unit 303 may include: a second acquisition subunit, configured to acquire item pick-up setting information corresponding to the second virtual character; and a third determination subunit, configured to obtain the pick-up parameter based on the item pick-up setting information.

In some embodiments, the acquisition unit 303 may include: a selection subunit, configured to select, from the at least two target virtual items, a virtual item that meets the item pick-up setting information, to obtain the first target virtual item.

In some embodiments, the determination unit 302 may include: a fourth determination subunit, configured to determine a distance between the first virtual character and each virtual item in the game scene according to the position information; and a fifth determination subunit, configured to determine the target virtual item based on a virtual item at a distance less than a preset distance from the first virtual character.

In some embodiments, the apparatus may further include: a providing unit, configured to provide a mark control on the graphical user interface.

In some embodiments, the second sending unit 305 may include: a fifth sending subunit, configured to send and display, in response to an information marking operation on the mark control, the marking information corresponding to the second target virtual item to the terminal device corresponding to the second virtual character.

An embodiment of the present disclosure discloses an apparatus for marking a virtual item, which controls, by the control unit 301, a first virtual character to move in a game scene in response to a movement instruction for the first virtual character; determines, by the determination unit 302, at least two target virtual items from the game scene according to position information of the first virtual character; acquires, by the acquisition unit 303, a pick-up parameter of the second virtual character, and determine at least one first target virtual item from the at least two target virtual items according to the pick-up parameter; sends and displays, by the first sending unit 304, marking information corresponding to the at least one first target virtual item to a terminal device corresponding to the second virtual character; and sends and displays, by the second sending unit 305, marking information corresponding to the second target virtual item to the terminal device corresponding to the second virtual character in response to a marking instruction triggered with regard to a second target virtual item by means of the graphical user interface, where the second target virtual item is a virtual item among the at least two target virtual items. In this way, the game experience of players can be improved, the running time of the terminal device can be reduced, and the power of the terminal device can be saved.

Correspondingly, an embodiment of the present disclosure further provides a computer device. The computer device may be a terminal. As shown in FIG. 11, FIG. 11 is a schematic structural diagram of a computer device provided by an embodiment of the present disclosure. The computer device 500 includes a processor 501 having one or more processing cores, a memory 502 having one or more computer-readable storage media, and a computer program stored in the memory 502 and executable on the processor. The processor 501 is electrically connected to the memory 502. Those skilled in the art can understand that the structure of the computer device shown in the drawing does not constitute a limitation of the computer device, and same may include more or fewer components than those shown in the drawing, or a combination of some components, or different component arrangements.

The processor 501 is a control center of the computer device 500, connects various parts of the entire computer device 500 using various interfaces and lines, performs various functions of the computer device 500 and processes data by executing or loading software programs and/or modules stored in the memory 502 and calling the data stored in the memory 502, to perform overall monitoring of the computer device 500.

In the embodiment of the present disclosure, the processor 501 in the computer device 500 loads instructions corresponding to processes of one or more application programs into the memory 502 according to the following steps, and the processor 501 executes the application programs stored in the memory 502, thereby implementing various functions: in response to a movement instruction for a first virtual character, controlling the first virtual character to move in a game scene; determining at least two target virtual items from the game scene according to position information of the first virtual character; acquiring a pick-up parameter of the second virtual character, and determining at least one first target virtual item from the at least two target virtual items according to the pick-up parameter; sending and displaying marking information corresponding to the at least one first target virtual item to a terminal device corresponding to the second virtual character; and in response to a marking instruction triggered with regard to a second target virtual item by means of the graphical user interface, sending and displaying marking information corresponding to the second target virtual item to the terminal device corresponding to the second virtual character, where the second target virtual item is a virtual item among the at least two target virtual items.

In some embodiments, the acquiring a pick-up parameter of the second virtual character includes: determining a close-range second virtual character based on a second virtual character at a distance not exceeding a preset distance from the first virtual character in the game scene; and acquiring a pick-up parameter of the close-range second virtual character.

In some embodiments, the sending and displaying marking information corresponding to the at least one first target virtual item to a terminal device corresponding to the second virtual character includes: sending and displaying the marking information corresponding to the at least one first target virtual item to a terminal device corresponding to the close-range second virtual character.

In some embodiments, the sending and displaying marking information corresponding to the second target virtual item to the terminal device corresponding to the second virtual character includes: determining a long-range second virtual character based on a second virtual character at a distance exceeding a preset distance from the first virtual character in the game scene; and sending and displaying the marking information corresponding to the second target virtual item to a terminal device corresponding to the long-range second virtual character.

In some embodiments, the second target virtual item is at least one first target virtual item the step of sending and displaying the marking information corresponding to the second target virtual item to a terminal device corresponding to the long-range second virtual character includes: sending and displaying marking information corresponding to the at least one first target virtual item to the terminal device corresponding to the long-range second virtual character.

In some embodiments, the second target virtual item is a virtual item other than the first target virtual item among the at least two target virtual items. The step of sending and displaying the marking information corresponding to the second target virtual item to a terminal device corresponding to the long-range second virtual character includes: sending and displaying marking information corresponding to the virtual item other than the first target virtual item among the at least two target virtual items to the terminal device corresponding to the long-range second virtual character.

In some embodiments, the acquiring a pick-up parameter of the second virtual character includes: acquiring item pick-up setting information corresponding to the second virtual character; and obtaining the pick-up parameter based on the item pick-up setting information.

In some embodiments, the determining at least one first target virtual item from the at least two target virtual items according to the pick-up parameter includes: selecting, from the at least two target virtual items, a virtual item that meets the item pick-up setting information, to obtain the first target virtual item.

In some embodiments, the determining at least two target virtual items from the game scene according to position information of the first virtual character includes: determining the distance between the first virtual character and each virtual item in the game scene according to the position information; and determining the target virtual item based on a virtual item at a distance less than a preset distance from the first virtual character.

In some embodiments, after the determining at least two target virtual items from the game scene according to position information of the first virtual character, the method further includes: providing a mark control on the graphical user interface. In response to a marking instruction triggered with regard to a second target virtual item by means of the graphical user interface, the step of sending and displaying marking information corresponding to the second target virtual item to the terminal device corresponding to the second virtual character includes: in response to an information marking operation on the mark control, sending and displaying the marking information corresponding to the second target virtual item to the terminal device corresponding to the second virtual character.

In this scheme design, a preset marking condition for a virtual character to mark a virtual item in a game scene is triggered, where the present marking condition includes the presence of a target virtual item in the game scene that is at a distance less than a preset distance from the virtual character; further, a second virtual character is selected from other game characters in the same game faction as the virtual character according to a preset marking-information sending condition, and then marking information of the target virtual item is sent to the second virtual character, so that the second virtual character picks up the target virtual item according to the marking information, which facilitates marking operations of players on the virtual item, improves the game experience of players, reduces the running time of the terminal device, and saves the power of the terminal device.

For specific implementation of the above operations, reference may be made to the foregoing embodiments, and details are not described herein again.

In some embodiments, as shown in FIG. 11, the computer device 500 further includes: a touch display screen 503, a radio-frequency circuit 504, an audio-frequency circuit 505, an input unit 506, and a power supply 507. The processor 501 is electrically connected to the touch display screen 503, the radio-frequency circuit 504, the audio-frequency circuit 505, the input unit 506, and the power supply 507, respectively. Those skilled in the art can understand that the structure of the computer device shown in the FIG. 11 does not constitute a limitation of the computer device, and same may include more or fewer components than those shown in the drawing, or a combination of some components, or different component arrangements.

The touch display screen 503 may be used to display a graphical user interface and receive operation instructions generated by a user acting on the graphical user interface. The touch display screen 503 may include a display panel and a touch panel. The display panel may be used to display information entered by or provided to the user as well as various graphical user interfaces of the computer device, which may be comprised of graphics, text, icons, videos, and any combination thereof. In some embodiments, the display panel may be configured in the form of LCD (liquid crystal display), OLED (organic light-emitting diode), or the like. The touch panel may be used to collect a touch operation on or near the user (e.g., an operation on or near the touch panel by the user using any suitable object or accessory such as a finger, a stylus pen, etc.), and to generate a corresponding operation instruction, wherein the operation instruction executes a corresponding program. In some embodiments, the touch panel may include two parts, a touch detector and a touch controller. The touch detector detects a touch orientation of the user, detects a signal triggered by the touch operation, and transmits the signal to the touch controller. The touch controller receives the touch information from the touch detector, converts the touch information into contact coordinates, and sends the contact coordinates to the processor 501, and can receive and execute commands from the processor 501. The touch panel may cover the display panel. When the touch panel detects a touch operation on or near the touch panel, the touch panel transmits the touch operation to the processor 501 to determine the type of the touch event. Then the processor 501 provides corresponding visual output on the display panel according to the type of the touch event. In the embodiment of the present disclosure, input and output functions may be implemented by integrating the touch panel and the display panel into the touch display screen 503. In some embodiments, however, the touch panel and the touch panel may be two separate components to perform input and output functions. More specifically, the touch display screen 503 may also serve as part of the input unit 506 to implement the input function.

The radio-frequency circuit 504 may be used to transmit and receive radio-frequency signals, to establish wireless communication with network devices or other computer devices via wireless communication, and to transmit and receive signals to and from the network devices or other computer devices.

The audio-frequency circuit 505 may be used to provide an audio interface between the user and the computer device through a speaker and a microphone. The audio-frequency circuit 505 may transmit an electrical signal obtained by converting the received audio data to the speaker which converts the electrical signal into a sound signal to be outputted. On the other hand, the microphone converts the collected sound signal into an electrical signal, which is received by the audio-frequency circuit 505 and then converted into audio data. The audio data is outputted to the processor 501 for processing, and then transmitted to, for example, another computer device via the radio-frequency circuit 504, or the audio data is outputted to the memory 502 for further processing. The audio-frequency circuit 505 may also include an earphone jack to provide communication between an external earphone and the computer device.

The input unit 506 may be used to receive inputted numbers, character information, or user characteristic information (e.g., fingerprint, iris, facial information, etc.), and to generate keyboard, mouse, joystick, optical, or trackball signal input related to user settings and function control.

The power supply 507 is used to power various components of the computer device 500. In some embodiments, the power supply 507 may be logically connected to the processor 501 through a power management system, to implement functions such as management of charging, discharging and power consumption through the power management system. The power supply 507 may further include one or more arbitrary components such as a DC or AC power supply, a recharging system, a power failure detection circuit, a power converter or inverter, and a power status indicator.

Although not shown in FIG. 11, the computer device 500 may further include a camera, a sensor, a wireless fidelity module, a Bluetooth module, and the like, which are not described in detail herein.

Each of the above embodiments is described with emphasis. For parts not described in detail in a certain embodiment, reference may be made to related descriptions of other embodiments.

As can be seen from the foregoing, the computer device provided in the present embodiment controls a first virtual character to move in a game scene in response to a movement instruction for the first virtual character determines at least two target virtual items from the game scene according to position information of the first virtual character; acquires a pick-up parameter of the second virtual character, and determines at least one first target virtual item from the at least two target virtual items according to the pick-up parameter; sends and displays marking information corresponding to the at least one first target virtual item to a terminal device corresponding to the second virtual character; and in response to a marking instruction triggered with regard to a second target virtual item by means of the graphical user interface, sends and displays marking information corresponding to the second target virtual item to the terminal device corresponding to the second virtual character, where the second target virtual item is a virtual item among the at least two target virtual items.

Those of ordinary skill in the art will appreciate that all or part of the steps in the various methods of the above embodiments may be implemented by instructions, or by instructions controlling related hardware, and the instructions may be stored in a computer-readable storage medium and loaded and executed by a processor.

To this end, an embodiment of the present disclosure provides a computer-readable storage medium storing a plurality of computer programs that can be loaded by a processor to perform the steps of any one of the methods for marking a virtual item provided by the embodiments of the present disclosure. For example, the computer program may perform the following steps: in response to a movement instruction for a first virtual character, controlling the first virtual character to move in a game scene; determining at least two target virtual items from the game scene according to position information of the first virtual character; acquiring a pick-up parameter of the second virtual character, and determining at least one first target virtual item from the at least two target virtual items according to the pick-up parameter; sending and displaying marking information corresponding to the at least one first target virtual item to a terminal device corresponding to the second virtual character; and in response to a marking instruction triggered with regard to a second target virtual item by means of the graphical user interface, sending and displaying marking information corresponding to the second target virtual item to the terminal device corresponding to the second virtual character, where the second target virtual item is a virtual item among the at least two target virtual items.

In some embodiments, the acquiring a pick-up parameter of the second virtual character includes: determining a close-range second virtual character based on a second virtual character at a distance not exceeding a preset distance from the first virtual character in the game scene; and acquiring a pick-up parameter of the close-range second virtual character.

In some embodiments, the sending and displaying marking information corresponding to the at least one first target virtual item to a terminal device corresponding to the second virtual character includes: sending and displaying the marking information corresponding to the at least one first target virtual item to a terminal device corresponding to the close-range second virtual character.

In some embodiments, the sending and displaying marking information corresponding to the second target virtual item to the terminal device corresponding to the second virtual character includes: determining a long-range second virtual character based on a second virtual character at a distance exceeding a preset distance from the first virtual character in the game scene; and sending and displaying the marking information corresponding to the second target virtual item to a terminal device corresponding to the long-range second virtual character.

In some embodiments, the second target virtual item is at least one first target virtual item. The step of sending and displaying the marking information corresponding to the second target virtual item to a terminal device corresponding to the long-range second virtual character includes: sending and displaying marking information corresponding to the at least one first target virtual item to the terminal device corresponding to the long-range second virtual character.

In some embodiments, the second target virtual item is a virtual item other than the first target virtual item among the at least two target virtual items. The step of sending and displaying the marking information corresponding to the second target virtual item to a terminal device corresponding to the long-range second virtual character includes: sending and displaying marking information corresponding to the virtual item other than the first target virtual item among the at least two target virtual items to the terminal device corresponding to the long-range second virtual character.

In some embodiments, the acquiring a pick-up parameter of the second virtual character includes: acquiring item pick-up setting information corresponding to the second virtual character; and obtaining the pick-up parameter based on the item pick-up setting information.

In some embodiments, the determining at least one first target virtual item from the at least two target virtual items according to the pick-up parameter includes: selecting, from the at least two target virtual items, a virtual item that meets the item pick-up setting information, to obtain the first target virtual item.

In some embodiments, the determining at least two target virtual items from the game scene according to position information of the first virtual character includes: determining the distance between the first virtual character and each virtual item in the game scene according to the position information; and determining the target virtual item based on a virtual item at a distance less than a preset distance from the first virtual character.

In some embodiments, after the determining at least two target virtual items from the game scene according to position information of the first virtual character, the method further includes: providing a mark control on the graphical user interface. In response to a marking instruction triggered with regard to a second target virtual item by means of the graphical user interface, the step of sending and displaying marking information corresponding to the second target virtual item to the terminal device corresponding to the second virtual character includes: in response to an information marking operation on the mark control, sending and displaying the marking information corresponding to the second target virtual item to the terminal device corresponding to the second virtual character.

In this scheme design, a preset marking condition for a virtual character to mark a virtual item in a game scene is triggered, where the present marking condition includes the presence of a target virtual item in the game scene that is at a distance less than a preset distance from the virtual character; further, a second virtual character is selected from other game characters in the same game faction as the virtual character according to a preset marking-information sending condition, and then marking information of the target virtual item is sent to the second virtual character, so that the second virtual character picks up the target virtual item according to the marking information, which facilitates marking operations of players on the virtual item, improves the game experience of players, reduces the running time of the terminal device, and saves the power of the terminal device.

For specific implementation of the above operations, reference may be made to the foregoing embodiments, and details are not described herein again.

The storage medium may include: a ROM (read only memory), a RAM (random access memory), a magnetic disk, or an optical disk, etc.

Since the computer program stored in the storage medium may execute the steps of any method for marking a virtual item provided by the embodiments of the present disclosure, the advantageous effects that can be achieved by any method for marking a virtual item provided by the embodiments of the present disclosure can be achieved, which are described in detail in the foregoing embodiments, and will not be described herein again.

The method and apparatus for marking a virtual item, the storage medium, and the computer device provided by the embodiments of the present disclosure have been described in detail above, and the principles and implementation manners of the present disclosure have been described herein by using specific examples. The description of the above embodiments is only used to help understand the method and the core concept of the present disclosure. Meanwhile, for a person skilled in the art, variations may be made to the specific embodiments and application range based on the idea of the present disclosure. In conclusion, the content of the present description should not be construed as limiting the present disclosure.

1. A method for marking a virtual item, comprising:
controlling, in response to a movement instruction for a first virtual character, the first virtual character to move in a game scene, wherein:
the game scene is displayed on a graphical user interface provided by a terminal device,
the graphical user interface comprises at least a portion of the game scene,
the first virtual character and a second virtual character are located in the game scene,
the first virtual character corresponds to the terminal device, and
the second virtual character and the first virtual character are in a same faction;
determining two target virtual items from the game scene based on position information of the first virtual character;
acquiring a pick-up parameter of the second virtual character, and determining a first target virtual item from the two target virtual items based on the pick-up parameter;
sending and displaying marking information corresponding to the first target virtual item to a terminal device corresponding to the second virtual character; and
in response to a marking instruction triggered with regard to a second target virtual item through the graphical user interface, sending and displaying marking information corresponding to the second target virtual item to the terminal device corresponding to the second virtual character, wherein the second target virtual item is one of the two target virtual items.

2. The method according to claim 1, wherein acquiring the pick-up parameter of the second virtual character comprises:
determining a close-range second virtual character based on the second virtual character being located within a preset distance from the first virtual character in the game scene; and
acquiring a pick-up parameter of the close-range second virtual character.

3. The method according to claim 2, wherein sending and displaying marking information corresponding to the first target virtual item to the terminal device corresponding to the second virtual character comprises:
sending and displaying the marking information corresponding to the first target virtual item to a terminal device corresponding to the close-range second virtual character.

4. The method according to claim 1, wherein sending and displaying marking information corresponding to the second target virtual item to the terminal device corresponding to the second virtual character comprises:
determining a long-range second virtual character based on the second virtual character being located beyond a preset distance from the first virtual character in the game scene; and
sending and displaying the marking information corresponding to the second target virtual item to a terminal device corresponding to the long-range second virtual character.

5. The method according to claim 4, wherein the second target virtual item is the same as the first target virtual item, and
sending and displaying the marking information corresponding to the second target virtual item to the terminal device corresponding to the long-range second virtual character comprises:
sending and displaying marking information corresponding to the first target virtual item to the terminal device corresponding to the long-range second virtual character.

6. The method according to claim 4, wherein the second target virtual item comprises a virtual item other than the first target virtual item among the two target virtual items, and
sending and displaying the marking information corresponding to the second target virtual item to the terminal device corresponding to the long-range second virtual character comprises:
sending and displaying marking information corresponding to the virtual item other than the first target virtual item among the two target virtual items to the terminal device corresponding to the long-range second virtual character.

7. The method according to claim 1, wherein acquiring the pick-up parameter of the second virtual character comprises:
acquiring item pick-up setting information corresponding to the second virtual character; and
obtaining the pick-up parameter based on the item pick-up setting information.

8. The method according to claim 1, wherein determining the first target virtual item from the two target virtual items based on the pick-up parameter comprises:
selecting, from the two target virtual items, a virtual item that matches item pick-up setting information, to obtain the first target virtual item.

9. The method according to claim 1, wherein determining the two target virtual items from the game scene based on the position information of the first virtual character comprises:
determining a distance between the first virtual character and each virtual item in the game scene based on the position information; and
determining virtual items located within a a preset distance from the first virtual character as the two target virtual items.

10. The method according to claim 1, further comprising:
providing a mark control on the graphical user interface; and
wherein, in response to the marking instruction triggered with regard to a second target virtual item through the graphical user interface, sending and displaying marking information corresponding to the second target virtual item to the terminal device corresponding to the second virtual character comprises:
in response to an information marking operation on the mark control, sending and displaying the marking information corresponding to the second target virtual item to the terminal device corresponding to the second virtual character.

11. (canceled)

12. A system, comprising:
one or more memories collectively containing one or more programs; and
one or more processors, wherein the one or more processors are configured to, individually or collectively, perform an operation comprising:
controlling, in response to a movement instruction for a first virtual character, the first virtual character to move in a game scene, wherein:
the game scene is displayed on a graphical user interface provided by a terminal device,
the graphical user interface comprises at least a portion of the game scene,
the first virtual character and a second virtual character are located in the game scene,
the first virtual character corresponds to the terminal device, and
the second virtual character and the first virtual character are in a same faction;
determining two target virtual items from the game scene based on position information of the first virtual character;
acquiring a pick-up parameter of the second virtual character, and
determining a first target virtual item from the two target virtual items based on the pick-up parameter:
sending and displaying marking information corresponding to the first target virtual item to a terminal device corresponding to the second virtual character; and
in response to a marking instruction triggered with regard to a second target virtual item through the graphical user interface, sending and displaying marking information corresponding to the second target virtual item to the terminal device corresponding to the second virtual character, wherein the second target virtual item is one of the two target virtual items.

13. One or more non-transitory computer-readable storage media containing, in any combination, computer program code that, when executable by a computer system, perform an operation comprising:
controlling, in response to a movement instruction for a first virtual character, the first virtual character to move in a game scene, wherein:
the game scene is displayed on a graphical user interface provided by a terminal device,
the graphical user interface comprises at least a portion of the game scene,
the first virtual character and a second virtual character are located in the game scene,
the first virtual character corresponds to the terminal device, and
the second virtual character and the first virtual character are in a same faction;
determining two target virtual items from the game scene based on position information of the first virtual character;
acquiring a pick-up parameter of the second virtual character, and determining a first target virtual item from the two target virtual items based on the pick-up parameter;
sending and displaying marking information corresponding to the first target virtual item to a terminal device corresponding to the second virtual character; and
in response to a marking instruction triggered with regard to a second target virtual item through the graphical user interface, sending and displaying marking information corresponding to the second target virtual item to the terminal device corresponding to the second virtual character, wherein the second target virtual item is one of the two target virtual items.

14. The system according to claim 12, wherein acquiring the pick-up parameter of the second virtual character comprises:
determining a close-range second virtual character based on the second virtual character being located within a preset distance from the first virtual character in the game scene; and
acquiring a pick-up parameter of the close-range second virtual character.

15. The system according to claim 14, wherein sending and displaying marking information corresponding to the first target virtual item to the terminal device corresponding to the second virtual character comprises:
sending and displaying the marking information corresponding to the first target virtual item to a terminal device corresponding to the close-range second virtual character.

16. The system according to claim 12, wherein sending and displaying marking information corresponding to the second target virtual item to the terminal device corresponding to the second virtual character comprises:
determining a long-range second virtual character based on the second virtual character being located beyond a preset distance from the first virtual character in the game scene; and
sending and displaying the marking information corresponding to the second target virtual item to a terminal device corresponding to the long-range second virtual character.

17. The system according to claim 16, wherein the second target virtual item is the same as the first target virtual item, and
sending and displaying the marking information corresponding to the second target virtual item to the terminal device corresponding to the long-range second virtual character comprises:
sending and displaying marking information corresponding to the first target virtual item to the terminal device corresponding to the long-range second virtual character.

18. The system according to claim 16, wherein the second target virtual item comprises a virtual item other than the first target virtual item among the two target virtual items, and
sending and displaying the marking information corresponding to the second target virtual item to the terminal device corresponding to the long-range second virtual character comprises:
sending and displaying marking information corresponding to the virtual item other than the first target virtual item among the two target virtual items to the terminal device corresponding to the long-range second virtual character.

19. The system according to claim 12, wherein acquiring the pick-up parameter of the second virtual character comprises:
acquiring item pick-up setting information corresponding to the second virtual character; and
obtaining the pick-up parameter based on the item pick-up setting information.

20. The system according to claim 12, wherein determining the first target virtual item from the two target virtual items based on the pick-up parameter comprises:
selecting, from the two target virtual items, a virtual item that matches item pick-up setting information, to obtain the first target virtual item.

21. The system according to claim 12, wherein determining the two target virtual items from the game scene based on the position information of the first virtual character comprises:
determining a distance between the first virtual character and each virtual item in the game scene based on the position information; and
determining virtual items located within a preset distance from the first virtual character as the two target virtual items.
